(19) United States
(12) Patent Application Publication
(10) Pub. No.: US 2020/0004272 A1
(43) Pub. Date: Jan. 2, 2020

(54) SYSTEM AND METHOD FOR INTELLIGENT AERIAL INSPECTION

(71) Applicant: Skyyfish, LLC, Missoula, MT (US)

(72) Inventor: Orest Jacob Pilskalns, Missoula, MT (US)

(73) Assignee: SKYYFISH, LLC, Missoula, MT (US)

(21) Appl. No.: 16/022,181

(22) Filed: Jun. 28, 2018

(51) Int. Cl. G05D 1/10; G08G 5/00; G06T 17/00; G01S 19/43

(52) U.S. Cl. CPC G05D 1/101; G08G 5/0034; G08G 5/0039; G08G 5/0069; G06T 7/0002; G01S 19/43; G06T 2207/30184; G06T 2207/10028; G06T 17/00

(57) ABSTRACT

A flight plan for an unmanned aerial vehicle is created based on a target to inspect. The plan can be based on the data obtained from one or more prior inspection flights for the same target. Flight plans can be automatically suggested to the users based on the analysis of data obtained during prior inspection flights.

### TECHNICAL FIELD

This application relates to the aerial inspection of structures such as towers, pylons and bridges. In particular, it relates to the processing of imagery of vertical structures collected with an unmanned aerial vehicle (UAV).

### BACKGROUND

Towers, particularly those used for communications and for supporting power lines, need to be regularly inspected for damage, deterioration and nearby growth of obstructive vegetation.

### SUMMARY OF INVENTION

The system and method disclosed herein relate to the use of a UAV for inspecting towers, radio masts, pylons, bridge suspensions, and other vertical structures. A flight plan for the inspection of the tower is created, including the flight path, the areas to inspect, the data to collect, and the timetable of the flight. The flight plan is then uploaded to a UAV, executed, and can be modified in flight if needed. The flight plan, if not the first flight plan for a given tower, may be dependent on prior flights and/or the data collected during such prior flights.

The disclosed system and method permit the optimization of missions (i.e. data collection flights) based on past data and the analysis of the past data. For example, after flying around a tower three times a year to inspect it, the system might predict using machine learning that it would be inefficient to photograph certain areas of the tower more than once a year.

Disclosed herein is a method for aerially inspecting a target, comprising the steps of: receiving, by a computer, identification of the target; receiving, by the computer, a path for inspecting the target; generating, by the computer, a flight plan based on the path; transmitting the flight plan to an unmanned aerial vehicle (UAV), wherein the UAV executes the flight plan, collects data relating to the target and aggregates flight meta-data with the collected data; transferring the flight meta-data and collected data from the UAV to the computer; and processing the data and meta-data to create a digital 3D model of the target. Vertical structures are a unique challenge, and require a complex approach that involves relative orientation of a camera or sensor while in control of yaw, pitch and roll of a UAV rising or descending while inspecting the structure from multiple camera angles. In a preferred embodiment, a “smart gimbal” is provided for the UAV.

Further disclosed is a system for aerially inspecting a target comprising an unmanned aerial vehicle (UAV), a server and a computing machine, also termed here a “control device”. The computing machine is configured to receive identification of the target, receive a path for inspecting the target, generate a flight plan based on the path, and transmit the flight plan to the UAV; wherein the UAV is configured to execute the flight plan, collect data relating to the target, and aggregate flight meta-data with the collected data; wherein the computer is configured to receive the flight meta-data and collected data from the UAV and transfer it to the server; wherein the server is configured to process the flight meta-data and collected data to create a digital 3D model of the target. Thus the UAV may have an avionics package that controls the pitch, speed and power of one or more blades, but the control device is tasked with flight meta-data that creates a three-dimensional map of the structure from the flight path and the imagery and other sensor data received from the UAV. Gimbal control is necessarily a function of the predicted flight path, but is also exquisitely sensitive to flight behavior that can only be adjusted instantaneously from the UAV platform, behaviors such as responses to wind gusts, downdrafts and updrafts around towers, glare, reflections and shadows. Gimbal control is also linked to meta-data factors such as collection angle requirements, e.g. obliques, nadirs, 45° shots at certain waypoints. A “smart gimbal” may aid in data collection and processing. In a preferred embodiment, machine learning is used to develop suitable algorithms and flow charts configured to each species, genus, or each individual structure according to the complexity of the task at hand. Thus, there is an unmet need for more sophisticated systems and the art continues to evolve.

### BRIEF DESCRIPTION OF DRAWINGS

The following drawings illustrate embodiments of the invention, which should not be construed as restricting the scope of the invention in any way.

FIG. 1 is a schematic drawing of a system for aerially inspecting towers, according to an embodiment of the disclosed invention.

FIG. 2 is a schematic drawing of a scenario in which the system is used to aerially inspect a communication tower.

FIG. 3 is a flowchart of a process carried out by the system to create a flight plan, according to an embodiment of the disclosed invention.

FIG. 4 is a flowchart of a process carried out by the system to execute a flight plan, according to an embodiment of the disclosed invention.

FIG. 5 is a screenshot showing an offset to a position of a UAV.

FIG. 6 is a flowchart of a process carried out by the system to retrieve data recorded during a flight plan, according to an embodiment of the disclosed invention.

FIG. 7 is a flowchart of a process carried out by the system to process data recorded during a flight plan, according to an embodiment of the disclosed invention.

FIG. 8 is a flowchart of a process carried out by the system to create a flight plan based on prior data, according to an embodiment of the disclosed invention.

FIG. 9 is a flowchart of a process carried out by the system to suggest flight plans based on prior data, according to an embodiment of the disclosed invention.

FIG. 10 is a flowchart of a process carried out by the system to calibrate control points used for a flight plan, according to an embodiment of the disclosed invention.

### DESCRIPTION

### A. Glossary

The term “target” relates to the object to be inspected using a UAV with a camera and/or other sensor or sensors, and using location determination technology such as a GPS (Global Positioning System). A target may be a communication tower, a cell tower, a radio mast, a power line pylon, a bridge, a building, a crane, or any other structure that lends itself to aerial inspection.

The term “control point” refers to a measured location in terms of latitude, longitude and altitude in relation to a target. Sometimes, control points are used to associate a location in an image with a known location on the globe. 3D waypoints are a class of control points that make up a flight path.

The term “gimbal” relates to a mechanism, typically consisting of rings pivoted at right angles, for keeping an instrument such as a sensor in a moving craft in a fixed orientation. The term may also be used to refer to a housing having such a mechanism.

The term “orthomosaic” is the joining together of multiple images using orthorectification. This involves removing perspective distortions from the images using a 3D model. Meta-data supplied with the images is used to provide a common coordinate system for the model. The product is a georeferenced image composite from a digital library of tagged images taken from different viewpoints, where any geometric distortion and foreshortening has been corrected and “orthorectified”. This is also termed “mosaicing” or “orthomosaic mapping” but is applied to structures having a primary “Z-axis” and secondary X and Y axes. Because distances are accurately represented in the model, the orthomosaic can be used for measurements.

The term “point cloud” refers to a set of data points in a 3D coordinate system. The points represent the external surface of an object.

The term “remote controller” refers to the electronic user computing device that a user uses to remotely control a UAV in real time.

The term “software” includes, but is not limited to, program code that performs the computations necessary for calculating and optimizing user inputs, controlling the UAV, controlling the gimbal, controlling the sensors, reporting and analyzing UAV specific data and sensor data, displaying information, analyzing data, processing data, suggesting flight plans, managing of input and output data, etc. Software is executed by a computing machine with processor, non-transitory memory for storing executable instructions, memory for receiving and transmitting data, and by supporting logic circuitry. Computing machines may include servers, desktops, laptops, and more and more has come to include the smart devices that are the descendants of what were once “cell phones”. These are generically termed “control devices”.

The term “firmware” includes, but is not limited to program code and data used to control and manage the interactions between the various modules of a system. Firmware can be, for example, an avionics package on board a UAV, or one or more hardware layers in a smart device.

The term “hardware” includes, but is not limited to, the physical housing for a computer or device, as well as the display screen if any, connectors, wiring, circuit boards having one or more processor and memory units, power supply, and other electrical and mechanical components, including ASICs and logic circuitry more generally, as well as analog devices and their digital counterparts.

The term “module” can refer to any component in this invention and to any or all of the features of the invention without limitation. A module may be a software, firmware or hardware module, and may be located in a gimbal assembly, the UAV, a user device or a server.

The term “network” can include both a mobile network and data network without limiting the term's meaning, and includes the use of wireless (e.g. 2G, 3G, 4G, WiFi, WiMAX™, Wireless USB (Universal Serial Bus), Zigbee™, Bluetooth™ and satellite), and/or hard wired connections such as internet, ADSL (Asymmetrical Digital Subscriber Line), DSL (Digital Subscriber Line), cable modem, T1, T3, fiber, dial-up modem, television cable, and may include connections to flash memory data cards and/or USB memory sticks where appropriate. A network could also mean dedicated connections between computing devices and electronic components, such as buses for intra-chip communications.

The term “processor” is used to refer to any electronic circuit or group of circuits that perform calculations, and may include, for example, single or multicore processors, multiple processors, an ASIC (Application Specific Integrated Circuit), and dedicated circuits implemented, for example, on a reconfigurable device such as an FPGA (Field Programmable Gate Array). The processor performs the steps in the flowcharts, whether they are explicitly described as being executed by the processor or whether the execution thereby is implicit due to the steps being described as performed by code or a module. The processor, if comprised of multiple processors, may be located together or geographically separate from each other. The term includes virtual processors and machine instances as in cloud computing or local virtualization, which are ultimately grounded in physical processors. Specialized processors may also be computers in their own right.

The term “user” is someone who interacts with the system to create flight plans, execute flight plans and manage the processing of collected data during the flights. A user may also be referred to as a pilot.

### B. Exemplary Embodiment

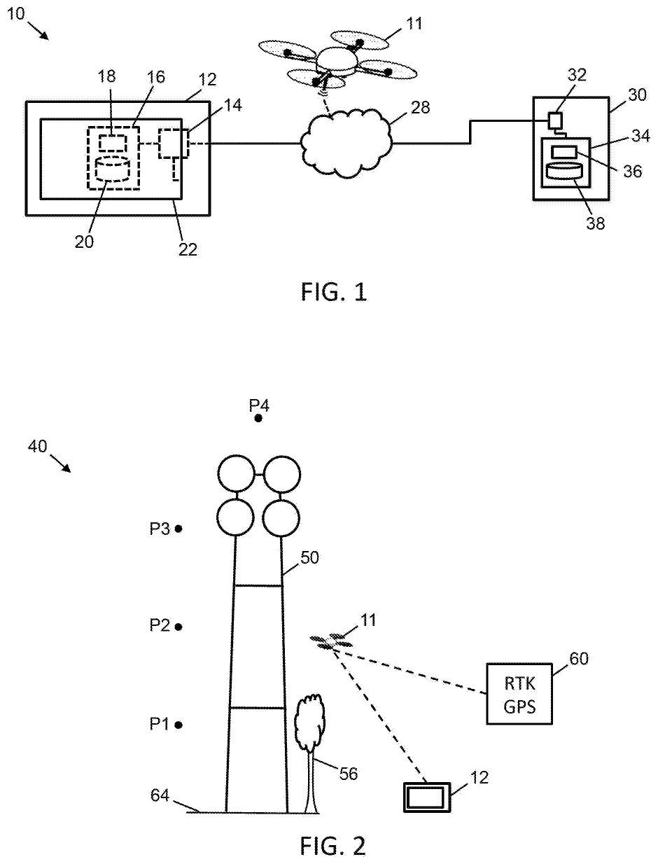

Referring to FIG. 1, shown is an exemplary system 10 for inspecting targets using a UAV 11. The system 10 includes or interacts with a user computing device 12, which may be a laptop or desktop computer, for example, or any other electronic device that provides the necessary equivalent functionality to fulfill the requirements of the invention. The user device 12 includes one or more processors 14 which are operably connected to computer readable memory 16 included in the device. The system 10 includes computer readable instructions 18 (e.g. an application) stored in the memory 16 and computer readable data 20, also stored in the memory. The memory 16 may be divided into one or more constituent memories, of the same or different types. The user device 12 includes a display screen 22, operably connected to the processor(s) 14. The display screen 22 may be a traditional screen, a touch screen, a projector, an electrofluidic or electrophoretic ink display, or any other technological device for displaying information.

The user computing device 12 is connected to or into the system via a network 28, which may, for example, be the internet, a telecommunications network, a local area network, a bespoke network or any combination of the foregoing. Communications paths in the network 28 may include any type of point-to-point or broadcast system or systems. The UAV 11 is connected to the network 28 wirelessly (e.g. via Bluetooth™) and optionally via a temporary wired connection.

The system 10 also includes a server 30, which has one or more processors 32 operably connected to a computer readable memory 34, which stores computer readable instructions 36 and computer readable data 38. Data 38 may be stored in a relational database, for example. Some or all of the computer readable instructions 18, 36 and computer readable data 20, 38 provide the functionality of the system 10 when executed or read by one or more of the processors 14, 32. Computer readable instructions may be broken down into blocks of code or modules.

The user device 12 is used to set-up a flight plan for inspecting particular targets. A user may set up the flight plan remotely from the target, using satellite imagery, for example. The flight plan may be created based on information obtained from prior flights around or to the same target that is retrieved from the database 38. The user device 12 may also be used as a remote controller to control the flight of the UAV 11 in real time.

FIG. 2 shows site 40 where the UAV 11 is in use for inspecting a communication tower 50. At the site 40, the user can perform a reconnaissance of the area surrounding the tower 50, and adjust the flight plan accordingly using the user device 12. For example, there may be unexpected vegetation 56, which was not present on the satellite image used for creating the flight plan. Other obstructions may also be present, such as debris. When the user is satisfied that the flight plan is acceptable, the flight plan is uploaded to the UAV 11, either wirelessly or by using a memory stick. At any moment, the updated plan can be saved to the server 30, provided there is a connection available.

When the UAV 11 has been switched on and loaded with the flight plan, the user can compare the actual physical location of the UAV with its position as indicated on a map that is displayed on user device 12. The location of the UAV 11 is determined with the use of an RTK (Real-Time Kinetic) GPS base station 60 at or near the site 40. The RTK GPS base station 60 may be set up temporarily by the user or it may already be installed at the site 40. The RTK GPS base station 60 corrects the determined location of the UAV 11 in real time. If there is a mismatch between the actual location and the displayed location, then the user can apply an offset to the flight plan, the displayed location or the map before the flight is started.

When the user starts the flight, the UAV 11 takes off and executes the flight plan. During the flight, the UAV 11 records data according to the plan, either using a camera and/or one or more sensors. As part of the flight plan, the UAV 11 may, for example, fly to predetermined points P1, P2, P3, P4 to take one or more photographs from each point. For example, the points P1, P2 and P3 are defined to face the north side of the tower 50, at heights of 10 ft, 20 ft and 30 ft off the ground 64. Point P4 is defined to be 10 ft above the top of the tower 50.

### C. Processes

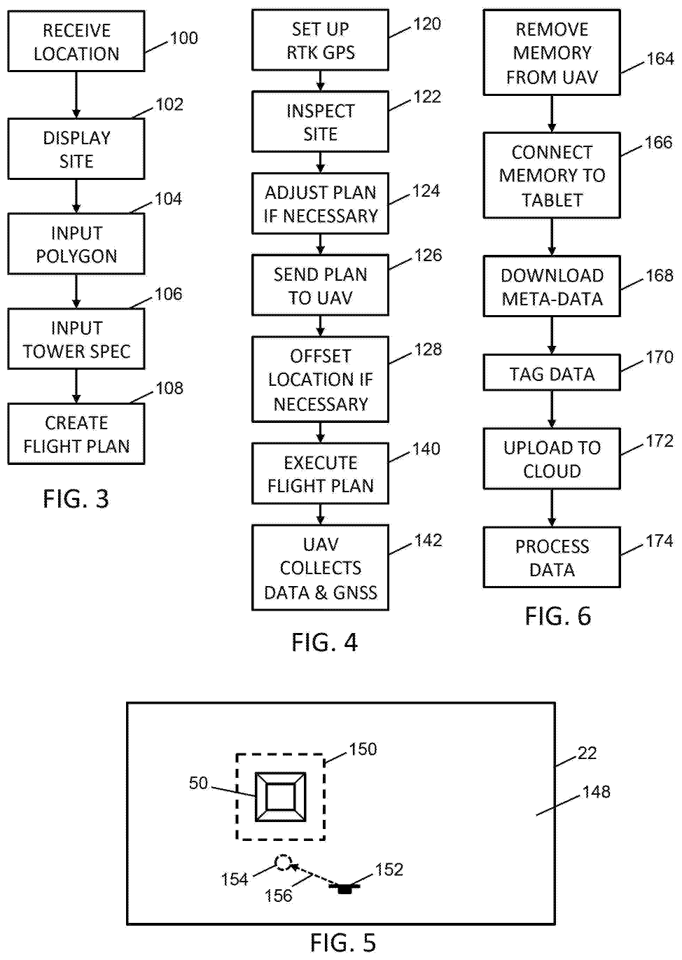

Referring to FIG. 3, a flowchart is shown for the creation of a flight plan. In step 100, the user device 12 receives a location from a user corresponding to a site 40 where there is a target 50 to be inspected. This may be achieved, for example, by the user entering a longitude and latitude on the user device 12, by pinpointing a location on a map, by selecting a feature on the map, or by any other known means. The user device 12 displays the site 40 of interest at the location, zoomed in if necessary, in step 102. In step 104, the user then draws a polygon or other shape around the displayed target 50 at the location, or drags and scales a template shape around the target. The user device 12 then requests, if not already provided, the specification of the target 50, such as the target's height, guy wire information (locations of tether points) and equipment information (dimensions, position on target), which are input in step 106.

When the system 10 has received the inputs from the user, in step 108 the user device 12 renders a flight plan based on the location, the polygon or other enclosing shape, and the specification of the target 50. The process of flight path generation can be broken down into a complex set of use-cases based on: target complexity; included equipment types; guy-wires; vegetation; terrain, etc. The user has the opportunity to modify the flight plan if the user so desires, and save the flight plan. The flight plan is created remotely from the sites, for example in the headquarters of an inspection company. In other embodiments, however, the flight plans may be created on-site.

The flight plan includes the requirements of the modeling software that will construct the eventual 3D model of the target. The modeling software has meta-data requirements, such as image overlap, angles, image-position and orientation. Angular orientation data is recorded for every sensor.

The meta-data requirements of the modeling software are based on the structural outline data entered by the user. Alternately, the structural outline data could be imported from another system. For example, a user may outline a tower and provide a height. The flight plan creation software will then generate a series of orbits around the tower to collect the appropriate meta-data and data and avoid any obstacles using radar, lidar, and/or optical sensors. Thus the flight plan is dynamic based on environmental conditions. The UAV onboard software preempts flight commands for safety. By including the angular meta-data, such as sensor angles etc., considerable processing time is saved during model creation. This is because typical 3D model creation software does not require the sensor angles to be input and instead calculates the angles, but if the actual angles are provided, then there is no need for them to be calculated.

Referring to FIG. 4, a flowchart undertaken by the system at the site of the target is shown. After taking the UAV 11 to the site, the user sets up the RTK GPS base station 60 in step 120. The user sets up the RTK GPS base station 60 at a known location (i.e. where there is a survey stake) or uses another RTK GPS base station in the area. The user may use a CORS (Continuously Operating Reference System) instead. RTK GPS base stations are used to correct the location information that is determined by the UAV 11 in real time.

In step 122, the user inspects the area of the site surrounding the target. This involves walking around the site looking for any issues such as trees, undocumented guy wires, power lines, unusual equipment configuration, etc. The extent of the inspection should be sufficient to compensate for the current limits of the collision detection capabilities of the UAV 11, using technologies such as radar detection, image recognition, and previous flight data integration.

In step 124, with the user computing device 12 switched on, the user makes adjustments to the flight plan if necessary, as a result of the site inspection.

The user then switches the UAV 11 on and in step 126 transfers the updated flight plan to the UAV if necessary, with the user computing device software in flight planning mode.

The user then navigates the software on the user computing device 12 into the flight mode. Now also referring to FIG. 5, we see the screen 22 of the user computing device 12 displaying a high-resolution map 148 with the target 50, and a portion of the flight plan 150 around the target. The user observes where an icon 152 representing the UAV 11 is located on the map. If the user finds that the icon 152 of the UAV 11 is not located on the map where expected (e.g. at location 154), the user offsets the position of the icon 152 (or the map or path), for example using on-site software offset tool, in step 128. In this example, the user applies an offset 156 to the measured position of the UAV 11 relative to the map.

The user then arms the UAV 11 by pushing a hardware Arm button on the UAV, and moves to a safe location to click on a takeoff button on the user device 12. The UAV 11 then starts to execute the flight plan in step 140.

In step 142, the UAV 11 collects the data it has been instructed to collect as it flies around the target 50. The flight path can be quite complex based on: A) target type, such as tower type, bridge design, etc.; B) sensor collection angle requirements, e.g. obliques, nadirs, 45° shots at certain points; C) resolution requirements, which might change the distances required for capturing images; or D) any combination of A), B) and C). For example, there may be a need for specially angled shots of cellular communication devices that are located at 150 ft above ground level. The data includes overlapped imagery (e.g. photographs, videos) and corresponding, simultaneous GNSS (Global Navigation Satellite System) data, such as GPS data, using the RTK GPS base station 60. Data may be collected using a camera and/or one or more sensors attached to a gimbal that is mounted on the UAV 11. In some embodiments, the gimbal may be a “smart gimbal” as described in U.S. Patent Application Publication No. 2018/0067493 published on 8 Mar. 2018, included herein by reference in its entirety. Using the smart gimbal, data aggregation, which is the combination of meta-data (location, speed, orientation, etc. of the UAV 11) with sensed data, is performed in flight. During the flight, which is observable by the user, the user has the option to click a button on the user computing device 12 to stop the flight and/or to order the UAV to return to home, in the event that the flight path begins to look dangerous or anomalous. The user may then use the user computing device 12 as a remote controller to manually control the flight of the UAV 11.

Referring to FIG. 6, a flowchart is shown of a process that occurs after the UAV 11 has completed a flight. After the flight, the user approaches the UAV 11 and disarms it with a second push of the hardware Arm button (or by pushing a separate Disarm button).

In step 164, the user opens the camera memory stick bay on the UAV 11, removes the memory stick containing picture data or video recordings and then inserts it into the user computing device 12 in step 166, where the data is optionally copied.

In step 168, the user computing device 12 automatically downloads the flight meta-data from the UAV 11 and starts tagging the photos based on time-stamps, in step 170.

In step 172, the user gets a message from the user device 12 asking whether to upload the tagged photos to the server 30. If so, the data is uploaded to the server 30, where it is processed in step 174. Data is processed in the server 30 with Pix4D™. If the data is processed on site in other embodiments, it is done using Bentley Systems (Exton, Pa.) software. When the data processing has been completed, the result is a digital 3D model of the target. The device 12 then notifies the user (or an email is sent from the processing software) that the model is ready for viewing. The model may be, for example, a 3D rendering of the target that can be viewed on screen from all around, from multiple angles and at different levels of zoom.

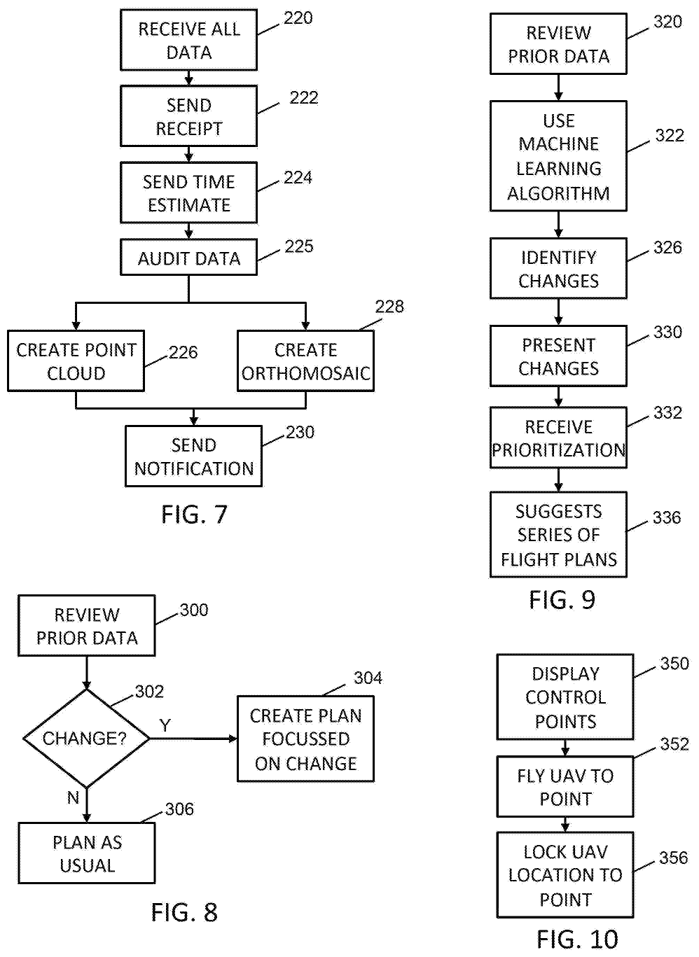

Referring to FIG. 7, a flowchart is shown for data post-processing at server 30, which can be performed provided that the meta-data is accurate and has been correlated with the recorded imagery.

Referring to step 220, the user computing device 12 contacts the post-processing cloud (i.e. the server 30) and authenticates the user-license for use of the post-processing service. As part of this process, the user may receive an upgrade message. The user is notified with a wait message while the data uploads. The user computing device 12 and the server 30 use an intelligent upload process, so that if the connection drops, data is not lost and the connection can be reestablished easily if lost.

When the data has been uploaded to server 30, the server sends a receipt message, in step 222, to the user device 12 and optionally an email stating that all the data has been uploaded.

In step 224, the server 30 gives an estimate of the time it will take to process the data.

In step 225, the server 30 audits the uploaded data to make sure that it is valid.

The server 30 then creates either a point cloud, in step 226; an orthomosaic, in step 228; or both a point cloud and an orthomosaic.

When the post-processing has been completed, the server 30 sends a notification, in step 230, to the user computing device 12 and/or an email saying that data is ready for download and viewing.

The server 30 may further offer options to convert data or to analyze the data. The server 30 may offer various analysis options (e.g. see Data Driven Inspection use-case, FIGS. 8 and 9).

The server 30 allows users to log in and view the processes at any time, and request the server to convert data, analyze data and/or create an analytic flight path. The server 30 may also give updates to the user from time to time.

Due to the time it might take to render the orthomosaic or 3D point cloud, which requires significant post processing to transform the images and meta-data into a measurable, accurate model, a preliminary model is created in some embodiments. This preliminary model requires minimal processing so that it is ready for the user shortly after the data has been collected and the UAV 11 has landed. The preliminary model includes, for example, a series of images labeled according to what face of the object the image represents, and with an embedded scale that represents some type of rough measurement. The scale is, for example, the height of the picture location as well as an embedded scale that is injected into the photo in flight, based on available meta-data (e.g. radar reading for distance to tower, coupled with lens specification). This rough model may be used for inventory, marketing, or preliminary inspection of the target object. For example, if a mission were flown to collect data for a four-faced communication tower, a simple representation of the tower could be shown in a document using the following format:
North Face:
   Picture 1, 2, 3—10 ft
   Picture 4, 5, 6—20 ft
   Picture 7, 8, 9—30 ft
South Face:
   Picture 1, 2, 3—10 ft
   Picture 4, 5, 6—20 ft
   Picture 7, 8, 9—30 ft
West Face:
   Picture 1, 2, 3—10 ft
   Picture 4, 5, 6—20 ft
   Picture 7, 8, 9—30 ft
East Face:
   Picture 1, 2, 3—10 ft
   Picture 4, 5, 6—20 ft
   Picture 7, 8, 9—30 ft

Referring to FIG. 8, a basic flowchart for data-driven inspection is shown. In step 300, the system reviews prior data. In step 302, the system determines whether there has been a change in the target between the last two times it was inspected. For example, the change could be that the mounting for a piece of equipment has become loose. If there has been a change, then in step 304 the system creates a flight plan that is focused on the detected change. For example, the flight plan may be to inspect only the suspect area of the target. If, however, there is no change detected in step 302, then, the flight plan is created as usual, in step 306.

There may be other ways in which the flight plan is modified. For example, if a change is detected as above, in step 302, then the scheduling of the subsequent flight may be amended. If the change represents potential safely hazards, then the flight is brought forward so that it can be executed sooner.

Referring to FIG. 9, a more detailed flowchart of data-driven inspection is shown. In step 320, a history of the collected data is analyzed. Users are continually uploading data to the server as time progresses, and so the history is analyzed each time that there is new data.

In step 322, the server 30 uses a machine learning algorithm to detect changes in the data as time progresses and as new data is added. In step 326, the server 30 has learned what sections of the data need to be re-examined and identifies the changes. In step 330, the changes are presented to the user, on the user computing device 12. The user then prioritizes the data sets corresponding to the identified changes based on the user's expert experience, and inputs the prioritization to be received by the user computing device 12 in step 332. The prioritization is then transmitted to the server 30. The server 30 then, in step 336, suggests a time frame for flights and corresponding flight paths according to the prioritization received from the user.

Referring to FIG. 10, a flowchart shows how control points are created. In step 350, the user device 12 displays control points on a map with elevation offsets. For example, the user might be requested by the software to position the UAV 11 at each of the control points. The control points may be, for example: on the ground ten feet diagonally out from each corner; hovering ten feet below each guy-wire; or ten feel directly above the tower. In step 352, the user positions or flies the UAV 11 to one of the control points. When the user feels that the craft is at the correct location for the control point, he taps the flight control software on the user device, which then communicates with the UAV to record its exact location. The location is determined with the use of the RTK GPS base station 60. The effect of this is to lock the current actual position of the UAV 11 to the control point as marked on the map displayed on the user device, as in step 356, resulting in calibration of the control point. In other embodiments, the pilot is requested to fly the 3D boundary defining visually safe zones. Safe zones are a 3D space surrounding the tower or other target in which the pilot can visually confirm that the UAV can fly unimpeded. The process of defining safe zones can be used for a subsequent, completely automated version of tower inspection.

The user repeats the process for each of the control points so that the software has a collection of 3D points that can be used to generate a flight path. The benefit of this is that the data is collected onsite. If the user only uses map data to draw the flight plan then there would be the risk that the UAV 11 could fly into the tower if the map data offset is greater than the flight path buffer zone, i.e. if the offset is greater than the safe distance from the tower. As a result of calibrating the control points, the flight software can create a more accurate flight plan using them.

At a minimum, in some embodiments, the user may be requested by the software to place the craft near the four corners of the tower, rather than to fly and hover at various locations.

### D. Variations

While the foregoing description has been given largely in terms of tower inspection, the invention is equally applicable to the inspection of other complex structures, such as bridges, buildings, roofs, etc.

Once the data has been successfully collected once, an autonomous landing, takeoff and charging station (ALTCS) may be left on site for the UAV in a fixed position. In this variation, the UAV can collect data according to a timetable, as determined by artificial intelligence, or manually. Such an automated landing, charging and takeoff station is described in U.S. Patent Application Publication No. 2017/0050749 published on Feb. 23, 2017, included herein by reference in its entirety. The ALTCS may be configured to include features of a control device or an adjunct to a control device in addition to its functions in power management and data transfer from the UAV to a ground station. Features in the ALTCS may include wide area radio or cellular networking capability for remote operation or operation according to an intelligent scheduler connected to a server at a centralized location. The currently disclosed process may be considered to be a calibration step for a fixed position autonomous landing, takeoff and charging station. By linking a fixed position ALTCS to a cellular radio system, a cellular tower inspection system is achieved that combines a structural inspection with a functional inspection, having both imaging and image processing and analysis features while also providing a simultaneous or synchronized test of tower function. The ALTCS may operate in conjunction with a smart gimbal and an avionics package on board the UAV so as to minimize response times. Alternatively, control functions operable locally with software may be instead directed by a remote server in close digital communication with the local devices.

Notifications and reports may be also sent from the ALTCS to smart devices for display to operators so as to automate supervisory and service tasks within the communications tower network and inspection system. The ALTCS units may include a WAN radio transceiver as a backup and may include an emergency power supply, but in a preferred embodiment are advantageously linked wirelessly or wiredly to cellular tower power and data cables that server an entire communications tower network.

The currently disclosed system and method may be used in a revenue sharing business, in which a person is an independent contractor that flies his own UAV. The person must satisfy a minimum set of requirements before being entitled to become a pilot, as must his UAV and/or camera, and the person may pay a subscription fee for the right to be a pilot. The business involves inspecting the target and further targets collectively and repeatedly by the UAV and further UAVs, wherein each UAV is independently piloted according to a centrally determined schedule. As currently practiced, the pilot and the business each receive a share of the inspection fee for doing the manual steps. A recurring fee is charged to the entities for storing and accessing the data that they are interested in.

Although the present invention has been illustrated principally in relation to UAVs it also has wide application in respect of other crafts and autonomous vehicles such as rovers.

While post-processing of the data collected during the flight has been described to occur at the server 30, it may also occur at the user computing device 12.

Data collected and orthomosaic models created may be disseminated outside of the system 10 if desired.

A risk model for the number of inspection flights per year and the areas to photograph can created based upon recorded data and expert evaluation. The users can then weigh the risk against the cost of the missions and find a trade-off that works for their business model.

The smart gimbal allows for more complex plans. For example, for tower inspection, the user can draw a circle or polygon around a tower on a map in planning mode. The user can specify that a special mode is activated. The flight software can have a tower mode that queries the user for structural information, such as the dimensions of the tower, equipment levels (height above ground), guy-wires, and more. The planning software automatically generates a new flight plan using the polygon as a rough estimate of the tower's location. The software can create, from the 2D (latitude and longitude) map based drawing, a 3D plan that extends the flight plan in the altitude dimension. Since the smart gimbal can add new sensors easily, the tower inspection use-case could take advantage of dual radar cones that can sense edges and obstacles. Thus, in this embodiment, a rough estimate of the tower location is all that is needed for a safe flight.

The plan could take into consideration 3D model building software (e.g. Bentley Systems, Exton Pa.) that uses photographs and the exact location of the photographs to build a point cloud. The point clouds (3D models) require that photographs be taken with various requirements including: overlap, angles (e.g. 45° above, oblique, 45° below), and centimeter-grade accuracy of camera using RTK GPS. Our software combined with the smart gimbal allows for a unique combination of data-driven navigation. The requirements of the model (resolution, area coverage, etc.) drive the flight path and sensor selection. Automatic or manual change detection of the model over time (several different data collection items spanning days, months or years) can be used to modify flight paths. For example, several flights might reveal that a communication antenna mounting is deflecting due to wind force. In another example, drone inspections can keep track on a communication tower of open space for rent at critical altitudes and angles.

If the user does not feel comfortable using complete automation, they can fly the path the first time manually, taking the craft to critical waypoints around the tower. The smart gimbal can then query the user as he flies craft, asking him to provide a rough path at several different altitudes around the tower. For example, the software might ask the user to avoid a danger envelop by flying the craft to approximately ten feet under a guy-wire and ten feet out from the tower. This envelop in essence would be a control point. The craft would automatically record the precise location and generate a safe path based on these points.

In yet another example, the user could set out remote devices that use RTK GPS to precisely find their locations, and report their locations back to the craft. In one case the user would set out such devices (i.e. remote beacons), one at a corner, crosspiece, cable mount, or level of a tower to provide an onsite marker of the tower locations.

The smart gimbal can calculate a flight path based on A) data collection needs, specifically model building, B) collision avoidance, C) previous safe flights, and/or D) multiple sensor needs (thermal and optical requirements might have a different overlap).

In general, unless otherwise indicated, singular elements may be in the plural and vice versa with no loss of generality. The use of the masculine can refer to masculine, feminine or both.

Throughout the description, specific details have been set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

The detailed description has been presented partly in terms of methods or processes, symbolic representations of operations, functionalities and features of the invention. These method descriptions and representations are the means used by those skilled in the art to most effectively convey the substance of their work to others skilled in the art. A software implemented method or process is here, and generally, understood to be a self-consistent sequence of steps leading to a desired result. These steps require physical manipulations of physical quantities. Often, but not necessarily, these quantities take the form of electrical or magnetic signals or values capable of being stored, transferred, combined, compared, and otherwise manipulated. It will be further appreciated that the line between hardware, firmware and software is not always sharp, it being understood by those skilled in the art that the software implemented processes and modules described herein may be embodied in hardware, firmware, software, or any combination thereof. Such processes may be controlled by coded instructions such as microcode and/or by stored programming instructions in one or more tangible or non-transient media readable by a computer or processor. The code modules may be stored in any computer storage system or device, such as hard disk drives, optical drives, solid-state memories, etc. The methods may alternatively be embodied partly or wholly in specialized computer hardware, such as ASIC or FPGA circuitry.

It will be clear to one having skill in the art that variations to the specific details disclosed herein can be made, resulting in other embodiments that are within the scope of the invention disclosed. Steps in the flowcharts may be performed in a different order, other steps may be added, or one or more steps may be removed without altering the main function of the system. Different flowcharts may be combined. All parameters, quantities, and configurations described herein are examples only and actual values of such depend on the specific embodiment.

Accordingly, the scope of the invention is to be construed in accordance with the substance defined by the claims.

I claim:

1. A method for aerially inspecting a target, comprising the steps of:
receiving, by a control device, identification of the target;
by the control device, receiving a path for inspecting the target and generating a flight plan based on the path, said flight plan comprising flight meta-data;
transmitting the flight plan to an unmanned aerial vehicle (UAV);
by the UAV, executing the flight plan, collecting data associated with the target, aggregating flight meta-data with the collected data, and transferring the flight meta-data and collected data from the UAV to the control device; and
processing the data and meta-data to create a digital 3D model of the target.

2. The method of claim 1, comprising processing the meta-data and collected data on a server in digital communication with the control device.

3. The method of claim 1, wherein the flight plan includes:
an area of the target to inspect;
an instruction of what data to collect; and,
predetermined points and angles from which the UAV is to take photographs of the target.

4. The method of claim 1, further comprising, by the control device, receiving input of dimensions of the target, wherein the target is a communication tower, a radio mast, a power line pylon, a bridge, a building or a crane.

5. The method of claim 1, further comprising the step of receiving, by the control device, when located on site at the target, a modification to the flight path before transmitting the flight plan to the UAV.

6. The method of claim 1, wherein the UAV has a current location, comprising:
determining a location of the UAV using a real-time kinetic global positioning system base station;
displaying the determined location of the UAV on a map on the control device; and,
applying an offset to the displayed location so that the displayed location corresponds to the current location of the UAV.

7. The method of claim 1, wherein:
the path is received as an input defining an envelope around the target;
the flight meta-data includes a location and an orientation of the UAV;
the aggregation is performed when the UAV is in flight; and,
the 3D model is a point cloud or an orthomosaic.

8. The method of claim 1, comprising tagging the collected data with timestamps.

9. The method of claim 1, comprising the step of processing the flight meta-data and collected data to create a preliminary model before the 3D model is created.

10. The method of claim 14, wherein the preliminary model comprises a series of images each labeled with a face of the target to which the image corresponds and embedded with a scale.

11. The method of claim 1, comprising:
analyzing, by the control device, two prior 3D models of the target; and,
basing the generation of the flight plan on said analysis.

12. The method of claim 11, further comprising scheduling the flight plan based on a change detected between the two prior 3D models.

13. The method of claim 11, further comprising presenting, by the control device, a change detected between the two prior 3D models.

14. The method of claim 1, further comprising calibrating a control point for the flight plan by:
displaying, on the control device, a marker corresponding to the control point;
positioning the UAV at the control point;
receiving, by the control device, an input indicating that the UAV is at the control point;
determining a current location of the UAV using a real-time kinetic global positioning system base station, while the UAV is at the control point; and,
associating the determined current location with the control point.

15. The method of claim 11, further comprising determining a safe zone for the flight plan by instructing a pilot of the UAV to fly the UAV in a 3D boundary around the target.

16. The method of claim 1, further comprising inspecting the target and further targets collectively and repeatedly by the UAV and further UAVs, wherein each UAV is independently piloted according to a centrally determined schedule.

17. A system for aerially inspecting a target, which comprises:
an unmanned aerial vehicle (UAV);
a server;
a control device;
wherein the control device is configured to:
receive identification of the target;
receive a path for inspecting the target;
generate a flight plan based on the path; and
transmit the flight plan to the UAV;
wherein the UAV is configured to:
execute the flight plan;
collect data relating to the target;
aggregate flight meta-data with the collected data;
receive the flight meta-data and collected data from the UAV and transfer it to the server; and,
wherein the server is configured to process the flight meta-data and collected data to create a digital 3D model of the target.

18. The system of claim 17, further comprising a real-time kinetic global positioning system base station, wherein the control device is configured to:
determine a location of the UAV using the real-time kinetic global positioning system base station;
display the determined location of the UAV on a map; and
apply an offset to the displayed location so that the displayed location corresponds to a current location of the UAV.

19. The system of claim 17, further comprising an autonomous landing, charging and take-off station at which the UAV automatically docks to charge batteries in the UAV before, during, or after the execution of the flight plan.

20. The system of claim 17, wherein said control device comprises an autonomous landing, charging and take-off station, and said station is configured with a cellular communications radio for data sharing in a communications tower network and inspection system.

21. The system of claim 17, further comprising a continuously operating reference system, wherein the control device is configured to:
determine a location of the UAV using the continuously operating reference system;
display the determined location of the UAV on a map; and
apply an offset to the displayed location so that the displayed location corresponds to a current location of the UAV.
